(19) United States
(12) Patent Application Publication
(10) Pub. No.: US 2018/0032681 A1
(43) Pub. Date: Feb. 1, 2018

(54) BIOLOGICAL FEATURE ANALYSIS TECHNIQUE

(71) Applicant: General Electric Company, Schenectady, NY (US)

(72) Inventors: Chandan Kumar Mallappa Aladahalli, Bangalore (IN); Dattesh Dayanand Shanbhag, Bangalore (IN); Rakesh Mullick, Bangalore (IN); Venkata Veerendra Nadh Chebrolu, Bangalore (IN); Ersin Bayram, Delafield, WI (US)

(21) Appl. No.: 15/224,364

(22) Filed: Jul. 29, 2016

(51) Int. Cl. G06F 19/00; G06F 3/0484; G06F 3/0482

(52) U.S. Cl. CPC G06F 19/322; G06F 19/3443; G06F 3/0482; G06F 3/04842

(57) ABSTRACT

The present disclosure relates to a method for assessing biological features, the method that includes rendering a graphical user interface allowing a user to select patient cohort information defining one or more characteristics of a patient cohort and allowing a user to select an analysis technique from a plurality of analysis techniques, wherein the analysis technique operates on the patient data from both the first data acquisition modality and the second data acquisition modality to generate a derived variable. The method also includes allowing a user to define a threshold for the derived variable to define a first patient group above the threshold and a second patient group below the threshold for each patient of a patient cohort.

### BACKGROUND

The subject matter disclosed herein relates to analysis of biological features or biological data and, in particular, for frameworks for multi-parameter analysis of biological data.

Clinicians and researchers have access to a number of analysis modalities that can provide data for various patient parameters. For example, certain imaging techniques rely on signal generators that have specific binding properties to analyze the presence and/or concentration of biomarkers that may be associated with particular clinical outcomes. Other diagnostic imaging techniques may include ultrasound imaging, magnetic resonance (MR) imaging, conventional radiography, computed tomographic (CT) imaging, etc. Such techniques may be used useful for detecting tumors, bleeding, aneurysms, lesions, blockage, infection, joint injuries, and assessing anatomical features.

In the case of protein or nucleic acid biomarker analysis, co-expression of two or more different biomarkers that correlate with a clinical condition may be analyzed in parallel by using the appropriate signal generators with binding properties for the desired biomarkers and assessing the data for expression co-intensity and/or co-location of the desired biomarkers. If the co-expression of the biomarkers is observed, the clinician may use the information as part of a diagnosis of the clinical condition.

However, while correlating data within a particular analysis modality may be relatively straightforward, e.g., comparing expression levels or location, correlation of data across analysis modalities may be more challenging, particularly when using retrospective data that is collected at various time points (i.e., longitudinal studies). Further, certain data may be collected or analyzed in vivo while other types of data are based on ex vivo collection or analysis. In addition, depending on the analysis modality, the information generated by a particular modality may not be stored as raw data, but instead may be processed and provided as indices or other parameter values that in turn are based on a combination of features.

### BRIEF DESCRIPTION

In one embodiment, a computer-implemented method for assessing biological features is provided. The method includes the steps of rendering a graphical user interface on a display device; rendering, on the graphical user interface, a cohort selection component allowing a user to select patient cohort information defining one or more characteristics of a patient cohort; rendering, on the graphical user interface, a parameter definition component allowing a user to select an analysis technique from a plurality of analysis techniques, wherein the analysis technique operates on primary variables in the patient data from a plurality of data acquisition modalities comprising at least a first data acquisition modality and a second data acquisition modality to generate a derived variable; accessing patient data from at least the first data acquisition modality and the second data acquisition modality for patients having the characteristics of the patient cohort; rendering, on the graphical user interface, a threshold component allowing a user to define a threshold for the derived variable to define one or more primary variables comprising an imaging feature of interest; receiving user input to select the one or more primary variables related to a plurality of biomarkers having available data from at least the first data acquisition modality and the second data acquisition modality; visualizing the plurality of biomarkers on the graphical user interface; determining the derived variables of the imaging features of interest using the analysis technique for each patient of the patient cohort having the available data of the first primary variable and the second primary variable from at least the first data acquisition modality and the second data acquisition modality, wherein the analysis technique operates on the first primary variable and the second primary variable for each patient to generate the derived variable; and displaying statistical information for patients of the patient cohort based on the derived variable, wherein the statistical information separate the patient cohort into a first group of patients have the defined variable above the threshold and a second group having the defined variable below the threshold.

In another embodiment, a method is provided that includes the steps of: the rendering a graphical user interface on a display device; rendering, on the graphical user interface, a parameter definition component allowing a user to select an analysis technique from a plurality of analysis techniques, wherein the analysis technique operates on a first primary variable determined from at least a first data acquisition modality and a second primary variable determined from at least a second data acquisition modality to generate a derived variable for an individual patient from the first primary variable and the second primary variable; accessing the patient data from at least the first imaging modality and the second imaging modality for patients of a patient cohort; determining the derived variable for each patient of the patient cohort having available data of the first primary variable and the second primary variable from the first imaging modality and the second imaging modality using the analysis technique; and determining a threshold for the derived variable that separates the patients into a first group of patients and a second group of patients that is nonoverlapping with the first group.

In another embodiment, a system for assessing biological features is provided that includes image acquisition circuitry configured to acquire image data of a plurality of patients; memory circuitry storing additional data of the plurality of patients; user interface circuitry configured to receive one or more user inputs; processing circuitry configured to: receive the image data and access the additional data from the memory and use the image data and the additional data to generate a derived variable with a defined threshold according to the user inputs; and provide an indication that the derived variable is valid when the defined threshold separates the plurality of patients into two or more groups, wherein each of the two or more groups is associated with a separate diagnosis or condition.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical illustration of a system for biological feature analysis, in accordance with aspects of the present specification;

FIG. 2 is a flow diagram of a method of biological feature analysis, in accordance with aspects of the present specification;

FIG. 3 is an illustration of a graphical user interface that facilitates user selection of patient data to define a feature of interest in accordance with aspects of the present specification;

FIG. 4 is an illustration of a graphical user interface that facilitates user selection of variables and operations to define a feature of interest in accordance with aspects of the present specification; and

FIG. 5 is a flow diagram of a method to identify a new biological feature of interest, in accordance with aspects of the present specification.

### DETAILED DESCRIPTION

Provided herein are implementations of a technique for assessing patient data to determine useful parameters for assessment of a patient's condition. Clinicians often use various testing or imaging modalities to obtain information about a patient to diagnose or predict a risk of a clinical condition, make predictions about the success of a particular therapy, or assess the results of a medical intervention. Applying the results from the testing modalities may be relatively straightforward, such as a blood test for a prostate specific antigen (PSA), whereby a concentration in a patient's blood above a certain value is indicative of a particular risk of developing prostate cancer. The assessment may increase in complexity when additional factors such as age are considered, whereby a particular PSA value for a younger patient is associated with a higher risk than the same PSA value in an older patient. Accordingly, an improved analysis may involve an age-based transform rather than a simple threshold analysis.

As medical technologies develop, clinicians have access to an increasing amount of data, but may not be able to form meaningful connections between different data sets, particularly data from different modalities (e.g., imaging data and blood test data) and/or data taken at different time points. While certain researchers may undertake a study of a particular clinical parameter in the context of another parameter, such studies often involve large cohorts of patients and may not be relevant if a patient does not fit within the defined cohort or does not have available the data defined in the study.

Provided herein are techniques to yield features of interest within a patient data set. The features of interest may represent new tests or diagnostic techniques that facilitate assessment of available patient data in a manner that is independent of the testing modality and that can be used to identify new parameters of clinical significance. For example, data from one or more patients may be used as inputs to the technique. In one implementation, the technique provides a user-modifiable analysis framework that facilitates assessment of the various correlations of the patient data for use in identifying biological parameters, e.g., biological features of interest. The techniques permit not only user selection of inputs of interest (e.g., type of data, patient characteristics), but also user selection of the analysis applied as well as user selection of threshold or range targets. Further, the techniques facilitate identification and manipulation of parameters-of-parameters. That is, if particular parameter values are used as first-level inputs, a second-level output may be generated by a transform or other manipulation of one or more input parameters.

User-selectable threshold values are applied to the derived variable to separate patients into two or more groups. Based on an analysis of the clinical characteristics of the patients in the two or mote groups, the quality of using a candidate feature of interest (e.g., the threshold applied to the derived variable) is determined. For example, if using the feature of interest separates patients according to a particular diagnosis for a disease (group one) and a lack thereof (group two), the feature of interest is assessed to be useful for diagnosing patients for whom parameter data is available but who are undiagnosed for the disease. In addition to second-level parameters, the present techniques, in particular implementations, also generate third or higher level parameter-of-parameters. That is, a first derived variable and a second derived variable, when used as inputs, generate a third-level derived variable output. The generated derived variables as inputs to a feature of interest may be used to make meaningful correlations in patient data to facilitate analysis of existing data. Further, such features may be used to generate a diagnosis for patients that lack particular imaging modality or other input data, but that have other types of input data that may permit analysis via one or more features as provided herein.

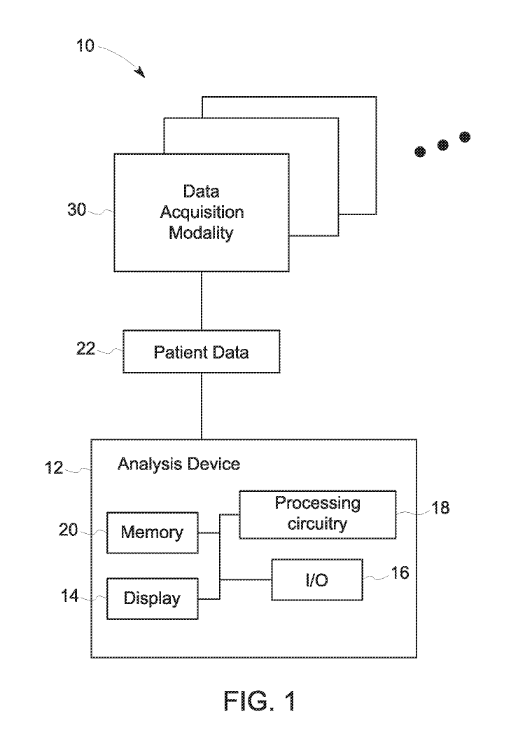

FIG. 1 is a block diagram of a system 10 for biological feature analysis that may be used in conjunction with the disclosed techniques. The system includes an analysis device 12 that includes a display 14 and I/O circuitry 16 to permit user interaction with a graphical user interface presented via the display 14. The analysis device 12 also includes processing circuitry 18 and memory circuitry 20 that stores instructions executable by the processing circuitry 18. The analysis device 12 may receive data 22 that is stored in the memory circuitry 20 from one or more data acquisition modalities 30. The data acquisition modalities 30 may include a magnetic resonance imaging system, an ultrasound imaging system, a contrast enhanced ultrasound imaging system, an optical imaging system, an X-ray imaging system, a computed tomography imaging system, a positron emission tomography imaging system, and so forth. The data acquisition modalities 30 may also include patient monitoring devices or blood lab value data acquisition devices. The received data is associated with one or more individual patients and their corresponding patient information, such as age, sex, physical characteristics (height, weight), medical history, and treatment history.

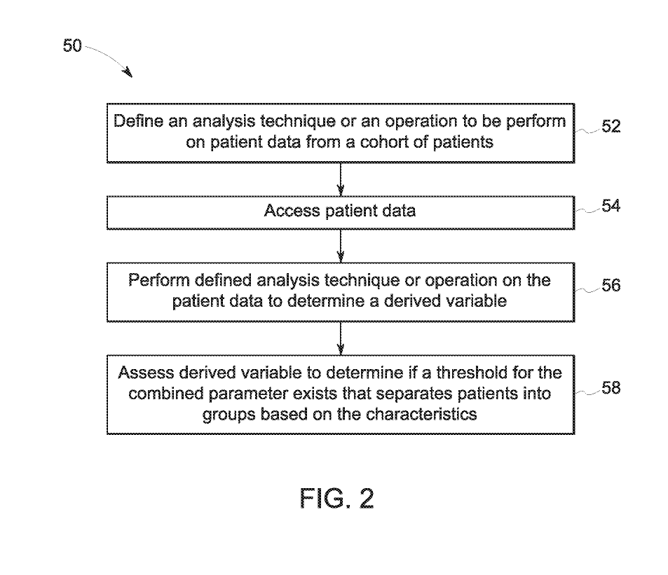

In operation, the analysis device 12 may perform or be used in conjunction with an operator performing one or more steps of a method 50 as shown in the flow diagram of FIG. 2. An operator may begin assessment of a derived variable of interest by interacting with a graphical user interface of a specially-programmed computer that is programmed to permit users to define an analysis technique or an operation to be performed on patient data (block 52) from a cohort of patients. The operation may be a statistical or mathematical operation that operates on the patient data or on parameters derived from the patient data. To that end, once the operation is defined by the user, the patient data is accessed (block 54) and the operation is performed on the patient data to determine the derived variable (block 56). If the patient cohort has well-defined characteristics, the derived parameter may be assessed to determine if a threshold for the derived variable exists that separates patients into groups based on the characteristics (block 58). If so, the derived variable and its associated threshold yield a feature of interest or a parameter of interest. In one embodiment, the analysis device may perform an aggregate operation on all of the determined defined variables (e.g., min, max, mean, histogram) and display the results to provide additional information about the patient cohort.

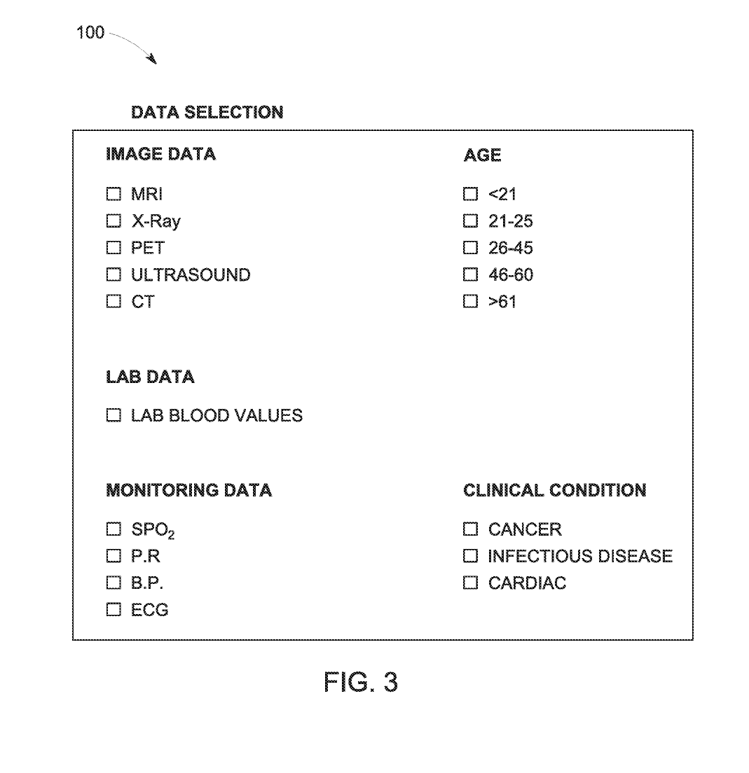

The patient data analysis techniques provided herein may be implemented on a graphical user interface that permits a user to access and define the desired analysis techniques. FIG. 3 is an example graphical user interface display 100 that may be implemented by the analysis device 12 to permit user interaction and selection of variables of interest. In one example, a user in discovery mode wishes to define a new derived parameter of interest from exiting variables in the patient data. In such an example, the user accesses patient data from an available patient pool. The patient pool may be patients associated with the user's facility or patients that have agreed to permit data to be used for investigation. Depending on the clinical application of the derived variable of interest, the user selects a patient cohort for analysis with particular characteristics such as age, gender, etc.

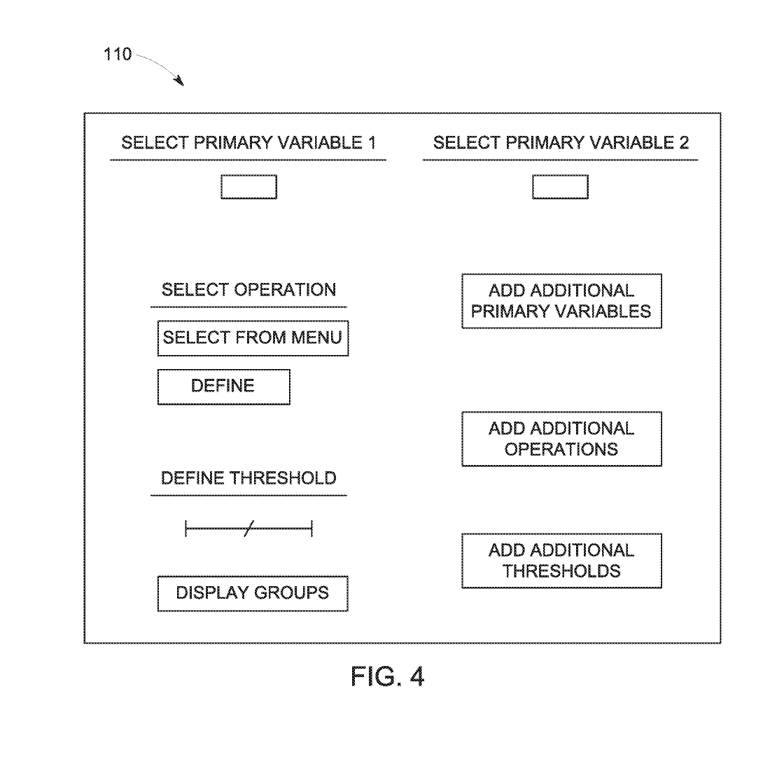

In another embodiment, the patient cohort may be defined by an available primary variable of interest. For example, if the user wishes to generate a derived variable that incorporates a particular primary variable, the first selection may be of patients that have data that is associated with the primary variable of interest. In a specific example, the user selects patients with available ECG data as the patient cohort. As shown in FIG. 4, a graphical user interface screen may also permit selection of a primary variable. In the example of ECG data, the user may select ECG-associated variables such as PR interval, QRS duration, QT interval, RR interval, pulse rate, mean electrical axis, etc, as the primary variable. Then, the user selects a second primary variable of interest (and, in certain embodiments, a third, fourth, fifth, etc.) for downstream operations. In the example of ECG data, the user may be interested in cardiac events. Accordingly, the second primary variable may be a C-reactive protein lab value. In another embodiment, the second primary variable is a calcium score determined from a cardiac CT scan. In yet another embodiment, the primary variable includes a voxel intensity value or a parameter derived therefrom. It yet another embodiment, the primary variable includes an apparent diffusion coefficient (ADC), a cerebral blood volume (CBV), or a standard uptake value (SUV).

Each primary variable is associated with a particular time point or time window. For example, the time point may be associated with a time relative to a defined baseline (e.g., date of first chemo-therapy treatment) such that the time point is expressed as t+ or t− time. The time may be an absolute, relative, or elapsed time. The user may define the primary variable as being from a particular time point or being relative to a time point of another primary variable.

The patient data may include primary variables generated by different types of data acquisition modalities. For example, a patient's pulse rate or heart rate variability may be determined by an ECG, a blood pressure monitoring device, and a pulse oximetry monitor. As provided herein, a user may specify that the variable of interest should be associated with a defined data acquisition modality. Alternatively, the user may indicate a preference for a source for the primary variable, such as ECG data, and permit the variable as determined from other data acquisition modalities to be used when data from the preferred source is unavailable. The user may also set data quality filters or tolerance levels that determine whether a particular patient's data is used.

In certain implementations, the patient data (e.g., patient data 22, FIG. 1) is provided post-processing and with the primary variables already calculated. In this manner, the analysis device (e.g., analysis device 12, FIG. 10 may not include functionality for processing raw data for a number of different data acquisition modalities. However, even for data that is received post-processing, one challenge associated with analysis of variables from different types of data acquisition modalities, or even of different diagnostic measurements from the same modality, is that the calculated variables may be expressed in different units. For example, glucose challenge results are expressed in milligrams per deciliter (mg/dL) or millimoles per liter (mmol/L). The present techniques may include a primary variable normalization step to automatically normalize the available patient data for a particular primary variable to the same units before performing any operations. In another embodiment, the present techniques may also include deriving desired primary variables from the available data set if such variables are not present. For example, for an ECG data set with an R-R value, the heart rate may be derived based on the R-R value.

Once two or more primary variables are selected, the user may interact with the graphical user interface to select an operation to be performed to generate the derived variable. In one embodiment, the user may manually define the mathematical operation. In another embodiment, certain operations may be selectable from a menu. For example, the selectable operations may include linear, quadratic, logarithmic, and exponential operations. Further, the user may define one or more mathematical operations on the primary variables at this stage. The mathematical operation or operations yield derived variables that in turn may be used to separate patients within the cohort. For example, the derived variable may be used as a score, with one or more thresholds separating patients having the primary variables into groups based on their derived variable value. The threshold is also user-defined, allowing the user to determine if changing the threshold yields improved predictive results.

To identify or assess a candidate feature of interest, after selection of the operation and determination of one or more derived variables, the user may assess the predictive significance of the derived variable and the user-selected threshold by comparing the patients separated into groups. Such assessment may be performed on retrospective patient data. For example, for a user wishing to assess a predictive variable for a myocardial infarction, assessment may involve determining if patients below the threshold are all myocardial infarction negative and patients above the threshold are all myocardial infarction positive (or vice versa) within a certain time frame. The threshold may be adjusted up or down to determine if such changes improve the predictive value.

In another embodiment, the disclosed techniques may be used to determine if the feature of interest is more predictive than existing predictive parameters. For example, the patient data may be assessed for a calcium score and separately assessed by a user-derived variable as provided herein. Based on an analysis of whether the calcium score accurately predicted the incidence of myocardial infarction within five years, the predictive value of the derived variable may be directly compared to the calcium score. If the calcium score missed any patients that had a zero score but had a cardiac event nonetheless in the time window in question (e.g., if the calcium score provided a false negative), the feature of interest may be assessed as more predictive by a measure of providing fewer false negatives. If the calcium score provided any false positives, the feature of interest may be assessed as more predictive by a measure of providing fewer false negatives. Accordingly, the feature of interest may be assessed for sensitivity and specificity relative to existing parameters. If the feature of interest is more specific and/or more sensitive, the derived variable may be a candidate for clinical trials or other studies.

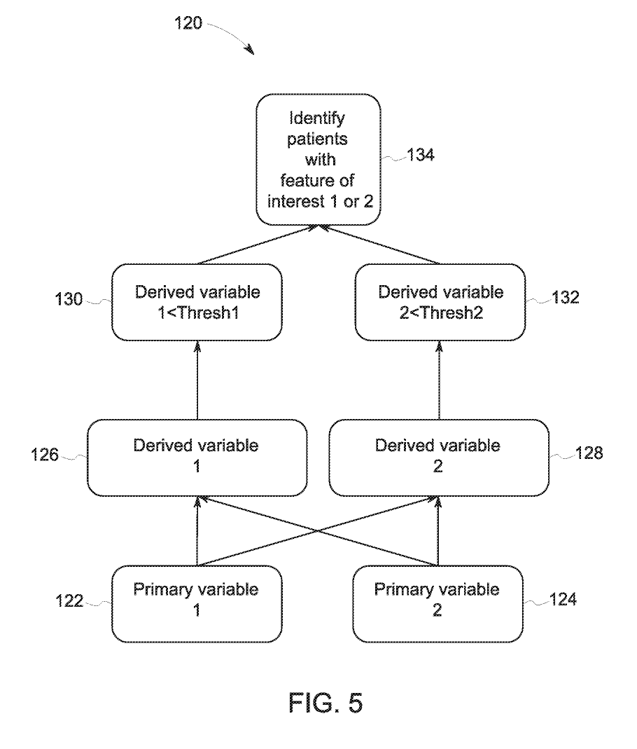

FIG. 5 is a flow diagram of a method 120 of identifying a feature of interest from a plurality of derived variables and respective applied thresholds. The depicted method 120 is an example of cross analysis between two user-selected primary variables, primary variable 1 (block 122) and primary variable 2 (block 124). Both primary variables are used as input to separate and different operations to generate derived variable 1 (block 126) and derived variable 2 (block 128). Separate thresholds are applied to each derived variable. Derived variable 1 has a first threshold applied, and only patients whose derived variable is less than the user-selected threshold are identified as having the feature of interest 1 (block 130). Derived variable 2 has a second threshold applied, and only patients whose derived variable 2 is less than the second threshold are identified as having the feature of interest 2 (block 132). The final feature of interest is the total set of patients having feature of interest 1 or feature of interest 2 (block 134). The remainder set non-overlapping with the identified set of patients may be assessed based on the patient data and medical records to determine if the feature of interest identifies patients with a desired specificity and/or sensitivity.

Technical effects of the invention include providing users the ability to use medical information from multiple different sources to create new and meaningful parameters for analysis. The techniques also may be used to assess the effectiveness of existing diagnostic tests and determine if combination with other variables may be used to yield more accurate predictive results. The techniques may be used in a variety of settings and may be implemented in conjunction with or independent of data acquisition modalities. Further, by permitting users to define relationships between variables as well as thresholds for the generated derived variables, the analysis of particular patient data sets may be customized to the available patient data.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for assessing biological features, the method comprising:
rendering a graphical user interface on a display device;
rendering, on the graphical user interface, a cohort selection component allowing a user to select patient cohort information defining one or more characteristics of a patient cohort;
rendering, on the graphical user interface, a parameter definition component allowing a user to select an analysis technique from a plurality of analysis techniques, wherein the analysis technique operates on primary variables in the patient data from a plurality of data acquisition modalities comprising at least a first data acquisition modality and a second data acquisition modality to generate a derived variable;
accessing patient data from at least the first data acquisition modality and the second data acquisition modality for patients having the characteristics of the patient cohort;
rendering, on the graphical user interface, a threshold component allowing a user to define a threshold for the derived variable to define one or more primary variables comprising an imaging feature of interest;
receiving user input to select the one or more primary variables related to a plurality of biomarkers having available data from at least the first data acquisition modality and the second data acquisition modality;
visualizing the plurality of biomarkers on the graphical user interface;
determining the derived variables of the imaging features of interest using the analysis technique for each patient of the patient cohort having the available data of the first primary variable and the second primary variable from at least the first data acquisition modality and the second data acquisition modality, wherein the analysis technique operates on the first primary variable and the second primary variable for each patient to generate the derived variable; and
displaying statistical information for patients of the patient cohort based on the derived variable, wherein the statistical information separate the patient cohort into a first group of patients have the defined variable above the threshold and a second group having the defined variable below the threshold.

2. The method of claim 1, wherein one or both of the first data acquisition modality and the second data acquisition modality are imaging modalities.

3. The method of claim 1, wherein the first data acquisition modality and the second data acquisition modality are the same.

4. The method of claim 1, wherein patient data from the first data acquisition modality and the second data acquisition modality are acquired at different time points from each individual patient having available data.

5. The method of claim 4, wherein the patient data from the second data acquisition modality is acquired in a defined time window relative to an acquisition time of the patient data from the first data acquisition modality.

6. The method of claim 1, rendering, on the graphical user interface, a second threshold component allowing a user to define a second threshold for the patient data from the first data acquisition modality or the second data acquisition modality.

7. The method of claim 6, wherein determining the derived variable comprises using only the patient data from the first data acquisition modality or the second data acquisition modality that is above the second threshold.

8. The method of claim 6, wherein determining the derived variable comprises using only the patient data from the first data acquisition modality or the second data acquisition modality that is below the second threshold.

9. The method of claim 6, wherein the second threshold defines a voxel value.

10. The method of claim 1, comprising rendering, on the graphical user interface, a tolerance component allowing a user to define a tolerance for the patient data from the first imaging modality or the second imaging modality.

11. The method of claim 10, wherein determining the derived variable comprises using only the patient data from the first imaging modality or the second imaging modality that is above the tolerance.

12. The method of claim 1, wherein the statistical information comprises an indication of a relationship of each determined derived variable to the threshold for the patient of the patient cohort in the first group and the second group.

13. The method of claim 1, wherein the analysis technique comprises operating on a first intermediate parameter calculated from patient data from the first data acquisition modality and a second intermediate parameter calculated from patient data from the second data acquisition modality.

14. The method of claim 1, wherein the analysis technique comprises an aggregate statistical analysis comprising a mean or histogram determined from the derived variables.

15. A computer-implemented method for assessing biological features, the method comprising:
rendering a graphical user interface on a display device;
rendering, on the graphical user interface, a parameter definition component allowing a user to select an analysis technique from a plurality of analysis techniques, wherein the analysis technique operates on a first primary variable determined from at least a first data acquisition modality and a second primary variable determined from at least a second data acquisition modality to generate a derived variable for an individual patient from the first primary variable and the second primary variable;
accessing the patient data from at least the first imaging modality and the second imaging modality for patients of a patient cohort;
determining the derived variable for each patient of the patient cohort having available data of the first primary variable and the second primary variable from the first imaging modality and the second imaging modality using the analysis technique; and
determining a threshold for the derived variable that separates the patients into a first group of patients and a second group of patients that is nonoverlapping with the first group.

16. The method of claim 15, wherein the first primary variable and the second primary variable are imaging variables calculated from raw imaging data from at least the first imaging modality or the second imaging modality.

17. The method of claim 15, wherein the patients in the first group exhibit a clinical condition that the patients in the second group do not exhibit.

18. The method of claim 17, wherein the patients in the first group have a cancer diagnosis and the patients in the second group do not.

19. The method of claim 17, wherein the patients in the first group have a cardiac diagnosis and the patients in the second group do not.

20. A system for assessing biological features, the system comprising:
image acquisition circuitry configured to acquire image data of a plurality of patients;
memory circuitry storing additional data of the plurality of patients;
user interface circuitry configured to receive one or more user inputs;
processing circuitry configured to:
receive the image data and access the additional data from the memory and use the image data and the additional data to generate a derived variable with a defined threshold according to the user inputs; and
provide an indication that the derived variable is valid when the defined threshold separates the plurality of patients into two or more groups, wherein each of the two or more groups is associated with a separate diagnosis or condition.

21. The system of claim 20, wherein the two or more groups comprise a first group associated with a positive cardiac diagnosis and a second group associated with a negative cardiac diagnosis, wherein patients in the first group are not in the second group.

22. The system of claim 20, wherein the additional data is a previously determined first primary variable and second primary variable based on the image data and wherein the processing circuitry is configured to operate on the first primary variable and the second primary variable according to the user inputs to determine the derived variable.
